(19) United States
(12) Patent Application Publication
(10) Pub. No.: US 2006/0057351 A1
(43) Pub. Date: Mar. 16, 2006

(54) Method for curing a binder on insulation fibers

(76) Inventors: Alain Yang, Villanova, PA (US); Francois Bouquet, Blue Bell, PA (US); Mark Trabold, Harleysville, PA (US)

Correspondence Address: DUANE MORRIS, LLP;IP DEPARTMENT, 30 SOUTH 17TH STREET, PHILADELPHIA, PA, 19103-4196, US

(21) Appl. No.: 10/939,277

(22) Filed: Sep. 10, 2004

(51) Int. Cl. B29C 71/00; B29C 71/02; B29B 17/00

(52) U.S. Cl. 428/292.1; 264/347; 264/348

(57) ABSTRACT

The invention relates to curing a binder on fibrous insulation (108), wherein, heated gas flows as a ratio of, an upward flow into the fibrous insulation (108), and a downward flow into the fibrous insulation (108), to heat the binder to its curing temperature; and the binder is cooled, thereby curing at least a portion of the binder to a thermoset state. When a remainder of the binder remains uncured, another stage of heating the binder with a ratio of heated gas followed by cooling, will cure the remainder of the binder.

### CROSS-REFERENCES TO RELATED APPLICATIONS

This application is related to U.S. patent application Ser. No. 10/851,535, filed May 21, 2004 (attorney docket D0932-00463). U.S. patent application Ser. No. 10/851,535, filed May 21, 2004 is a continuation in part of U.S. patent application Ser. No. 10/781,994, filed Feb. 19, 2004, which is a continuation-in-part of the following copending United States patent applications: U.S. patent application Ser. No. 10/689,858, filed Oct. 22, 2003; U.S. patent application Ser. No. 09/946,476, filed on Sep. 6, 2001; and U.S. patent application Ser. No. 10/766,052, filed on Jan. 28, 2004; which are commonly assigned and hereby incorporated by reference.

This application is also related to U.S. Pat. No. 6,673,280, issued Jan. 6, 2004, and U.S. patent application Ser. No. 10/766,052, filed on Jan. 28, 2004, U.S. patent application Ser. No. 10/782,275, filed on Feb. 19, 2004, U.S. patent application Ser. No. 10/781,994, filed on Feb. 19, 2004, U.S. patent application Ser. No. 10/806,544 filed Mar. 23, 2004 and U.S. patent application Ser. No. 10/823,065 filed Apr. 12, 2004, which are also commonly assigned and hereby incorporated by reference herein.

### BACKGROUND OF THE INVENTION

The invention relates generally to the field of curing a binder on fibrous insulation. A mass of numerous insulation fibers are bonded to one another with a thermoset binder, which forms a lofted fibrous insulation having a desired density and a rated, R-value thickness. One type of fibrous insulation is adapted for filling cavities in walls and ceilings of a building, thus, lowering the heat transfer rate through the insulation. Another type of fibrous insulation is a duct liner for lining a ventilation air duct. The duct liner lowers the heat transfer rate through the insulation, and further, reduces noise associated with air flow through the air duct. The fibrous insulation can be covered with a facing layer, for example, in the form of a flexible sheet or web, that provides an air stream surface and/or that controls vapor transmission through the insulation.

During manufacture of fibrous insulation, a binder is dispersed among numerous insulation fibers, and a collective mass of the insulation fibers are assembled on a conveyor to form a lofted fibrous insulation. The fibrous insulation is conveyed by the conveyor through a curing oven for curing the binder. The binder is either a liquid based binder, usually in an emulsion or solution, or a dry binder, usually in powder form. Alternatively, the dry binder is a thermoset polymer in fibrous form that is dispersed among the insulation fibers. The binder is cured by heating the binder to its curing temperature. The binder undergoes a phase change to attain a thermoset state. Further, the binder bonds the insulation fibers to one another in the lofted fibrous insulation.

To cure the binder, heated gas is directed to flow into the fibrous insulation. The temperature of the heated gas corresponds to a curing temperature of the binder. However, the free flow of heated gas to the interior of the fibrous insulation is resisted by a thickness of the fibrous insulation and by the density of the fibrous insulation. Consequently, the binder on insulation fibers within an interior of a thick fibrous insulation will cure at a slower curing rate than the binder on insulation fibers at or near an exterior of the fibrous insulation. A fibrous insulation formed by a known air laid process will have a uniform density of the insulation fibers throughout. However, a known accumulation process of making a fibrous insulation assembles the insulation fibers according to an uneven distribution, creating short-cut air flow paths among corresponding insulation fibers in the fibrous insulation. When heated gas is directed into the fibrous insulation to cure the binder, the short-cut air flow paths become hot spots. The binder on the corresponding insulation fibers will cure at a high curing rate due to the hot spots, while the binder on other insulation fibers will cure at a slow curing rate.

There is a current need for a method of curing a binder on insulation fibers of a fibrous insulation, by compensating for a slow curing rate of the binder on insulation fibers located within an interior of the fibrous insulation. Further there is a current need for a method of curing a binder on insulation fibers, by compensating for a high curing rate of the binder on corresponding insulation fibers among which short-cut air flow paths are present.

### BRIEF SUMMARY OF THE INVENTION

The invention relates to a method of curing a binder on insulation fibers of a fibrous insulation by, adjusting a temperature of a heated gas to a binder curing temperature, and directing the heated gas to flow in an adjusted ratio of, downwardly into the fibrous insulation and upwardly into the fibrous insulation, to cure the binder and to compensate for a slow curing rate of the binder on corresponding insulation fibers within an interior of the fibrous insulation.

According to an embodiment of the present invention, a method of curing a binder on insulation fibers of a fibrous insulation comprises, directing a flow of the heated gas, either as an upward flow into the fibrous insulation, or as a combination of the upward flow and a downward flow into the fibrous insulation, and exhausting the heated gas to cool the binder.

According to a further embodiment of the present invention, a method of curing a binder on insulation fibers of a fibrous insulation comprises, recirculating at least a portion of the heated gas flow to form a recirculating gas flow; and combining flame heated ambient air with the recirculating gas flow to form the heated gas flow that is directed into the insulation fibers.

According to a further embodiment of the present invention, a method of curing a binder on insulation fibers of a fibrous insulation comprises, directing a flow of the heated gas, either as an upward flow into the fibrous insulation, or as a combination of the upward flow and a downward flow into the fibrous insulation, to cure the binder and to compensate for a slow curing rate of the binder on corresponding insulation fibers within an interior of the fibrous insulation, followed by, exhausting the heated gas, and directing cooling air onto the fibrous insulation to cool the binder on corresponding insulation fibers among which short-cut air flow paths are present.

Further, the invention relates to a fibrous insulation having insulation fibers, and a binder on the insulation fibers being cured by, adjusting a temperature of a heated gas to a binder curing temperature, and directing the heated gas to flow in an adjusted ratio of, downwardly into the fibrous insulation and upwardly into the fibrous insulation, to cure the binder and to compensate for a slow curing rate of the binder on corresponding insulation fibers within an interior of the fibrous insulation.

According to an embodiment of the present invention, a fibrous insulation has insulation fibers and a binder on the insulation fibers, the binder being cured by a process comprising: recirculating at least a portion of the gas flow to form a recirculating gas flow; and combining flame heated ambient air with the recirculating gas flow to form the gas flow that is directed into the insulation fibers.

Embodiments of the invention will now be described by way of example with reference to the following detailed description and the accompanying drawings.

### BRIEF SUMMARY OF THE DRAWINGS

FIG. 1 is a schematic view of apparatus for curing a binder on insulation fibers on a conveyor moving through the apparatus.

FIG. 2 is a schematic view of apparatus for forming a heated gas flow that is directed into the insulation fibers.

FIG. 3 is a schematic view of apparatus for applying a facing to a fibrous insulation.

### DETAILED DESCRIPTION OF THE EMBODIMENTS

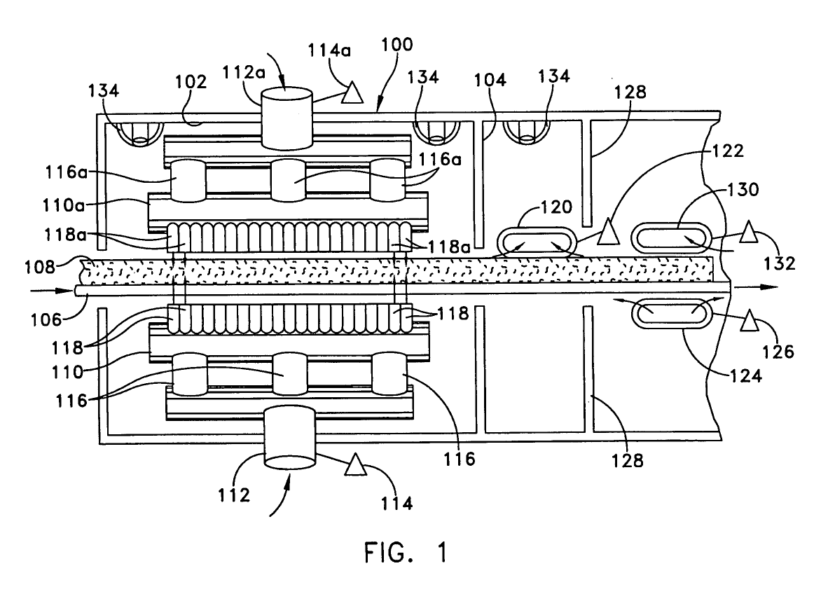

FIG. 1 discloses a curing oven (100) having a heavily insulated heating zone chamber (102), and an adjacent, insulated cooling zone chamber (104). A combination of a heating zone chamber (102) and a cooling zone chamber (104) forms a single stage of the curing oven (100). A continuous moving conveyor (106) supports a fibrous insulation (108) formed by a mass of numerous insulation fibers that are assembled on the conveyor (106). A binder is dispersed among the insulation fibers, and the insulation fibers are assembled on the conveyor (106) to form a lofted fibrous insulation (108).

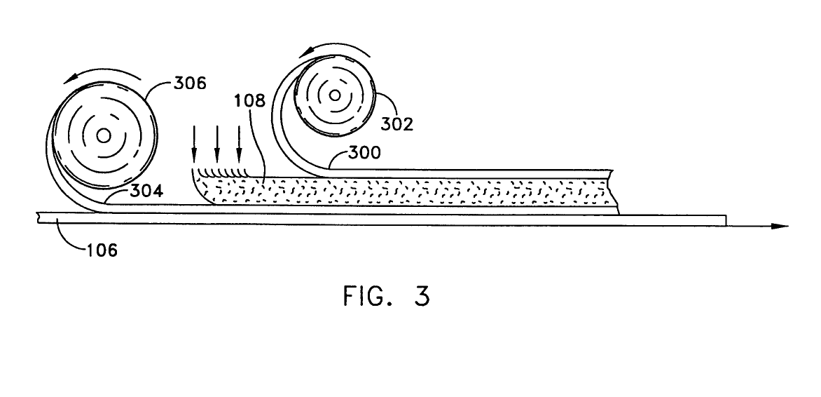

FIG. 3 discloses another embodiment of the fibrous insulation (108). A continuous web of glass fiber non-woven facing layer (300) may be dispensed from a roll (302) and is applied to at least one of the two major sides of the fibrous insulation (108) before the fibrous insulation (108) enters the curing oven (100). The facing layer (300) is a flexible sheet or film that is attached to, and covers, at least one major surface of the fibrous insulation (108) of insulation fibers. The facing layer (302) includes a sound absorbing film and/or a vapor barrier that repels or otherwise regulates the absorption level of atmospheric water vapor into the insulation.

In the exemplary process illustrated in FIG. 3, the non-woven facing layer (300) is applied to the major side that is the top side of the fibrous insulation (108) as it enters the curing oven (100), but depending on the particular need and preference in laying out the fabrication process, the non-woven facing layer (300) may be applied to the bottom side of the fibrous insulation (108). In another embodiment of the present invention, a non-woven facing layer (300) may be applied to both sides of the fibrous insulation (108). According to another embodiment of the present invention, a reinforcement layer (304) of a glass non-woven sheet, dispensed from a roll (306) may be used as a base layer for the duct liner of the present invention to provide additional mechanical support. The non-woven sheet may be applied to the fibrous insulation (108) at the bottom of the fibrous insulation (108) and heated or cured together.

FIG. 1 discloses that the fibrous insulation (108) is conveyed by the conveyor through the curing oven (100) for curing the binder. A bottom manifold (110) has a bottom inlet duct (112) for conveying heated gas, typically heated air. An adjustable control (114) adjusts the flow rate of heated gas through the bottom inlet duct (112). The bottom inlet duct (112) supplies multiple distribution ducts (116) feeding the bottom manifold (110). The manifold (110) distributes heated gas among numerous, upwardly directed, outlet ducts (118) that are spaced closely to one another to create an even distribution of heated gas directed upwardly through the moving conveyor (106) and into a bottom of the fibrous insulation (108) being conveyed by the conveyor (106). The heated gas is directed into the fibrous insulation (108) to cure the binder. Advantageously, the conveyor (106) is porous to the flow of heated gas. Further, the conveyor (106) has a mass as small as possible to assure rapid heating to the temperature of the heated gas. Further, the conveyor (106) rapidly cools when the fibrous insulation (108) is cooled. Further, the conveyor (106) may have magnetic properties to retain the same on a drive mechanism, which will limit the upper range of the heating temperature of the oven (100).

FIG. 1 discloses that a top manifold (110a) has a top inlet duct (112a) for conveying heated gas, typically heated air. An adjustable control (114a) adjusts the flow rate of heated gas through the top inlet duct (112a). The top inlet duct (112a) supplies multiple distribution ducts (116a) feeding the top manifold (110a). The top manifold (110a) distributes heated gas among numerous, downwardly directed, outlet ducts (118a) that are spaced closely to one another to create an even distribution of heated gas directed downwardly and into a top of the fibrous insulation (108) being conveyed by the conveyor (106). The heated gas is directed into the fibrous insulation (108) to cure the binder.

Further, FIG. 1 discloses an exemplary exhaust duct (120) downstream from the heating zone chamber (102). One or more insulation covered, exhaust ducts (120) are provided in the cooling zone chamber (104) immediately downstream from the heating zone chamber (102). Each exhaust duct (120) exhausts the gas flow laterally relative to either the upward flow or the downward flow of the heated gas. Each exhaust duct (120) has an adjustable control (122), for example, an adjustable motor control damper, to regulate the amount of recirculated gas exhausted from the cooling zone chamber (104). At least a portion of the heated gas flow, after being directed into the fibrous insulation (108) to heat and cure the binder, is exhausted via the one or more exhaust ducts (120) to become a recirculated gas flow.

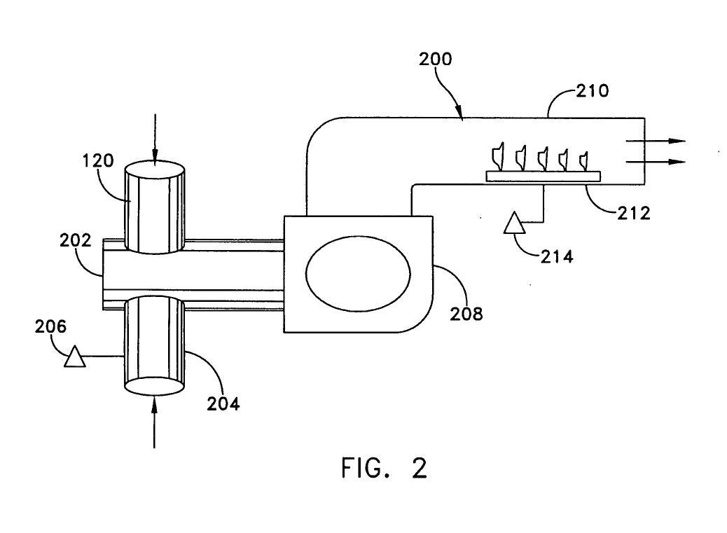

FIG. 2 discloses an insulation covered, recirculation system (200). A downstream end of the exhaust duct (120) serves as an input duct connected to an air supply chamber (202) to supply the recirculated gas to the air supply chamber (202). An input air duct (204) is connected to the air supply chamber (202) to supply ambient air to the air supply chamber (202). The input air duct (204) has an adjustable control (206), for example, an adjustable motor control damper, to adjust the rate of input air supplied to the supply chamber (202). For example, the ratio of the ambient air flow to recirculated gas flow is adjusted by appropriate adjustments of the adjustable controls (206) and (122). A downstream end of the supply chamber (202) supplies the ambient air flow and the recirculated gas flow to an axial fan (208) that impels the ambient air and the recirculated gas through a heater (210).

In the heater (210), a burner (212), of natural gas, for example, heats the ambient air and reheats the recirculated gas. The reheated, recirculated gas combines with the flame heated ambient air to become the heated gas that is supplied to the heating zone chamber (102). In the heater (210), the heated gas is heated to at least a curing temperature of the binder, preferably, somewhat higher that the curing temperature of the binder. The temperature is adjusted by an adjustable control (214) on the burner (212) to regulate the flame. A downstream end of the heater (210) disclosed by FIG. 2, is connected to both the bottom inlet duct and the top inlet duct disclosed by FIG. 1, to supply the heated gas thereto.

FIG. 1 further discloses a cooling air supply duct (124) in the cooling zone chamber (104). One or more cooling air supply ducts (124) are provided in the cooling zone chamber (104) downstream from the exhaust ducts (120). Each cooling air supply duct (124) directs cooling air into the fibrous insulation (108) to rapidly cool the fibrous insulation (108). An adjustable control (126), for example, a motor control adjustable damper, adjusts the supply rate of the cooling air. An insulated baffle (128) between the exhaust ducts (120) and the cooling air supply ducts (124) tends to isolate the cooling air from both the heated gas and the exhaust ducts (120) for the heated gas. Further, a secondary exhaust duct (130) in the cooling zone chamber (104) exhausts the cooling air after it has cooled the fibrous insulation (108). Further, the secondary exhaust duct (130) exhausts the cooling air to maintain a negative pressure in the cooling zone chamber (104), which further isolates the cooling air from the exhaust ducts (124) for the heated gas. The secondary exhaust duct (130) has an adjustable control (132), for example, a motor control adjustable damper, to adjust a flow rate through the secondary exhaust duct (130). For fire prevention, sprinkler heads (134) of a water sprinkler system are provided in the curing oven (100).

With further reference to FIG. 1, a fibrous insulation (108) on the conveyor is conveyed through the heating zone chamber (102) by continuous movement of the conveyor (106). Heated air is supplied to the bottom inlet duct (112). The heated gas is directed upwardly into the fibrous insulation (108). The bottommost section of the insulation has the highest density due to the weight in proportion to the thickness of the fibrous insulation (108). The binder on the fibrous insulation (108) of highest density tends to have the slowest curing rate. Thus, the upwardly directed, heated gas will tend to cure the bottom of the fibrous insulation (108) that has the highest density.

Further, heated air is supplied to the top inlet duct (112a). The heated gas is directed downwardly into the fibrous insulation (108). Initially, the binder on the fibrous insulation (108) is heated by a heated gas flow ratio of 1:1, of downwardly directed flow to upwardly directed flow. The fibrous insulation (108) emerging from the heating zone chamber (102) is inspected for complete curing throughout the fibrous insulation (108).

For an embodiment of the fibrous insulation (108) having a relatively large thickness, and/or high density, the binder cures at a low curing rate. When inspection reveals that curing of the binder on an interior of the fibrous insulation (108) is incomplete, the ratio is adjusted such that the flow rate of either the upward or downward flow is increased to penetrate the heated gas farther into the interior of the fibrous insulation (108), to completely cure the binder on the interior of the fibrous insulation (108).

When one or more surfaces of the fibrous insulation (108) is covered by respective facing layers (300) and/or the reinforcement layer (304), the gas flow ratio is adjusted to compensate for, and overcome, an increased resistance to gas flow due to the corresponding layer (300) and/or the layer (304). For example, the gas flow ratio is adjusted to increase the upward flow into the fibrous insulation (108) while a top surface of the fibrous insulation (108) is covered with a facing layer (300). Further, for example, the gas flow ratio is adjusted to increase the downward flow into the fibrous insulation (108) while a bottom surface of the fibrous insulation (108) is covered with a reinforcing layer (306). Further, for example, the gas flow ratio is adjusted for directing the gas flow as a combination of the upward flow and the downward flow while a top surface of the fibrous insulation (108) is covered with a first facing layer (300), and a bottom surface of the fibrous insulation (108) is covered with a second facing layer (300).

Cooling air flows in the cooling zone chamber (104) to cool the fibrous insulation (108). For an embodiment of the fibrous insulation (108) that has hot spots revealed by inspection of the fibrous insulation (108), the binder can be cooled to its thermoset state by cooling the fibrous insulation (108) with the cooling air. However, when the hot spots are required to be cooled, while a remaining portion of the binder remains uncured, then, one or more subsequent stages of the curing oven (100), as required, will cure the remaining portion of the binder.

The curing oven (100) is provided with multiple stages, each stage having a heating zone chamber (102) and a cooling zone chamber (104). In a first stage, hot spots are produced by heated gas flowing in short-cut air flow paths among corresponding insulation fibers in the fibrous insulation. The binder on the corresponding insulation fibers will cure at a high curing rate due to the hot spots, and is heated to a curing temperature, in a first stage heating zone chamber (102), followed by being cooled in a first stage, cooling zone chamber (104). The binder undergoes a phase change to a thermoset state. The remaining portion of the binder on other portions of the fibrous insulation (108) may remain uncured. In each following stage, an additional portion of the binder is heated and cooled, i.e. cured, to a thermoset state, such that, in one or more stages, as required, the remaining portion of the binder becomes cured to a thermoset state. The binder that has previously attained a thermoset state is unchanged by subsequent stages of the curing oven (100), which allows substantial heat transfer from the heated air to the uncured binder.

For an embodiment of the fibrous insulation (108) having a relatively large thickness, and/or high density and/or is covered on one or more major surfaces by respective facing layers (300) and/or reinforcing layer (304), the binder cures at a low curing rate. When an inspection reveals that a remaining portion of the binder in the interior of the fibrous insulation (108) is uncured, then multiple stages of the curing oven (100), as required, perform curing of the remaining portion of the binder.

In a first stage, the binder on the outer sections of the fibrous insulation (108) is heated and cooled to a thermoset state. The remaining portion of the binder on other portions of the fibrous insulation (108) may remain uncured. In each following stage, an additional portion of the binder is heated and cooled, i.e. cured, to a thermoset state, such that, in one or more following stages, as required, the remaining portion of the binder becomes cured to a thermoset state. The binder that has previously attained a thermoset state is unchanged by subsequent stages of the curing oven (100), which allows substantial heat transfer from the heated air to the uncured binder.

Embodiments of the fibrous insulation (108) have a density from 0.3 pcf (pounds per cubic foot) to 6 pcf, and more preferably from 1.0 pcf to 3 pcf. The thickness thereof is ⅛ inch to 8 inches, and more preferably form 1.0 inches to 6 inches. A continuous facing layer (300) is attached to and covers, a bottom, major surface of the fibrous insulation (108), a top, major surface, or both the bottom major surface and the top major surface. The line speed conveying the fibrous insulation (108) through the heating zone chamber (102) varies from 10 feet per minute to 100 feet per minute. The air distribution is divided between upwardly directed air and downwardly directed air according to a ratio of 20%, 30%, 40% and 50%, which are increments of 10%.

The disclosure of every patent, patent application, and publication cited herein is hereby incorporated herein by reference in its entirety.

While this invention has been disclosed with reference to specific embodiments, it is apparent that other embodiments and variations of this invention can be devised by others skilled in the art without departing from the true spirit and scope of the invention. The appended claims include all such embodiments and equivalent variations.

What is claimed is:

1. A fibrous insulation having insulation fibers and a binder dispersed on the insulation fibers, the binder being cured by a process comprising:
adjusting a temperature of a heated gas flow to at least a binder curing temperature;
directing the heated gas flow as a ratio of, an upward flow into the fibrous insulation, and a downward flow into the fibrous insulation;
the ratio being adjusted to compensate for a thickness and density of the fibrous insulation, to cure the binder and to compensate for a slow curing rate of the binder on corresponding insulation fibers within an interior of the fibrous insulation; and
cooling the binder, thereby curing the binder to a thermoset state.

2. The fibrous insulation of claim 1, further comprising:
recirculating and heating at least a portion of the heated gas flow to form a recirculating gas flow; and
combining ambient air with the recirculating gas flow to form the heated gas flow.

3. The fibrous insulation of claim 2, further comprising: adjusting a ratio of the recirculating gas flow and the ambient air.

4. The fibrous insulation of claim 1, further comprising: heating the fibrous insulation, then cooling the fibrous insulation, to cure at least a portion of the binder to a thermoset state; followed by a subsequent stage of heating the fibrous insulation, followed by cooling the fibrous insulation, to cure a remaining portion of the binder to a thermoset state.

5. The fibrous insulation of claim 1, further comprising: exhausting the gas flow laterally relative to either the upward flow or the downward flow.

6. The fibrous insulation of claim 1, further comprising:
increasing the upward flow into the fibrous insulation to compensate for a top surface of the fibrous insulation being covered with a facing layer.

7. The fibrous insulation of claim 1, further comprising:
increasing the downward flow into the fibrous insulation to compensate for a bottom surface of the fibrous insulation being covered with a reinforcing layer.

8. The fibrous insulation of claim 1, further comprising:
adjusting the ratio of the upward flow, and the downward flow, to compensate for a top surface of the fibrous insulation beings covered with a first facing layer, and a bottom surface of the fibrous insulation being covered with a second facing layer.

9. The fibrous insulation of claim 1, further comprising: adjusting the ratio of the upward flow and the downward flow to overcome a resistance to gas flow due to one or more facing layers on corresponding surfaces of the fibrous insulation.

10. The fibrous insulation of claim 9, further comprising: heating the fibrous insulation followed by cooling the fibrous insulation, to cure at least a portion of the binder to a thermoset state; followed by a subsequent stage of heating the fibrous insulation followed by cooling the fibrous insulation, to cure a remaining portion of the binder to a thermoset state.

11. A method for curing a binder on insulation fibers of an insulation fibrous insulation, comprising:
adjusting a temperature of a heated gas flow to at least a binder curing temperature; and
directing the heated gas to flow in an adjusted ratio of, downwardly into the fibrous insulation and upwardly into the fibrous insulation, to cure the binder and to compensate for a slow curing rate of the binder on corresponding insulation fibers within an interior of the fibrous insulation.

12. The method of claim 11, further comprising: adjusting the ratio of the upward flow and the downward flow.

13. The method of claim 11, further comprising:
recirculating and heating at least a portion of the heated gas flow to form a recirculating gas flow;
combining ambient air with the recirculating gas flow to form the heated gas flow; and
adjusting a ratio of the recirculating gas flow and the ambient air.

14. The method of claim 11, further comprising: heating the fibrous insulation, then cooling the fibrous insulation, to cure at least a portion of the binder to a thermoset state; followed by a subsequent stage of heating the fibrous insulation, followed by cooling the fibrous insulation, to cure a remaining portion of the binder to a thermoset state.

15. The method of claim 11, further comprising: exhausting the gas flow laterally relative to either the upward flow or the downward flow.

16. The method of claim 11, further comprising:
increasing the upward flow into the fibrous insulation to compensate for a top surface of the fibrous insulation being covered with a facing layer.

17. The method of claim 11, further comprising:
increasing the downward flow into the fibrous insulation to compensate for a bottom surface of the fibrous insulation being covered with a reinforcing layer.

18. The method of claim 11, further comprising:
adjusting the ratio of the upward flow, and the downward flow, to compensate for a top surface of the fibrous insulation beings covered with a first facing layer, and a bottom surface of the fibrous insulation being covered with a second facing layer.

19. The method of claim 11, further comprising: adjusting the ratio of the upward flow and the downward flow to overcome a resistance to gas flow due to one or more facing layers on corresponding surfaces of the fibrous insulation.

20. The method of claim 19, further comprising: heating the fibrous insulation followed by cooling the fibrous insulation, to cure at least a portion of the binder to a thermoset state; followed by a subsequent stage of heating the fibrous insulation followed by cooling the fibrous insulation, to cure a remaining portion of the binder to a thermoset state.
